(19) United States
(12) Patent Application Publication
(10) Pub. No.: US 2015/0074073 A1
(43) Pub. Date: Mar. 12, 2015

(54) APPARATUS, SYSTEM, AND METHOD FOR EVENT-IDENTIFIED CONTENT EXCHANGE AND MANAGEMENT

(71) Applicant: CEBEYE, INC., Torrance, CA (US)

(72) Inventor: Bing Liu, Rolling Hills, CA (US)

(21) Appl. No.: 14/459,366

(22) Filed: Aug. 14, 2014

Related U.S. Application Data
(60) Provisional application No. 61/875,878, filed on Sep. 10, 2013.

(51) Int. Cl. G06F 17/30

(52) U.S. Cl. CPC G06F 17/30864; G06F 17/3089
USPC 707/706

(57) ABSTRACT

An event-identified content apparatus, system and method. The invention comprises an application including an event creator, wherefrom a user creates a public, social, or private event associated with the user's account, a content associator, wherein content is associated with the created event, a plurality of channels, wherein the associated content is accessible to at least one other user based at least one permissions associated with a one of the plurality of channels with which the event is associated, and a search engine, whereby is provided a keyword search for the associated content by the at least one other user.

### CROSS-REFERENCE TO RELATED APPLICATIONS

This application claims priority to U.S. Provisional Patent Application Ser. No. 61/875,878, filed Sep. 10, 2013, entitled “Apparatus, System, and Method for Event-Identified Content Exchange and Management”, the entirety of which is incorporated herein by reference as if set forth herein in its entirety.

### BACKGROUND OF THE INVENTION

1. Field of the Invention

The present invention is directed to exchanging and managing content, and, more particularly, to an apparatus, system and method for event-identified content exchange and management.

2. Description of the Background

Typical content exchange and management systems do not lend themselves to a data exchange structure that readily allows for the management of different contexts for the data exchange. For example, social media data exchange cannot be modified to allow for data exchange in a taxation context.

Thus, the need exists for an apparatus, system and method for event-identified content exchange and management.

### BRIEF DESCRIPTION OF THE FIGURES

The present invention will be described in conjunction with the incorporated figures, in which like numerals represent like elements, and in which:

FIG. 1 is a block diagram of an exemplary computing device that may be used as a user terminal in the herein disclosed systems and methods.

FIG. 2 is a block diagram of a plurality of user terminals and a server, that may be used in the herein disclosed systems and methods.

FIG. 3 illustrates exemplary aspects in accordance with the herein disclosed systems and methods.

FIG. 4 illustrates exemplary aspects in accordance with the herein disclosed systems and methods.

FIG. 5 illustrates exemplary aspects in accordance with the herein disclosed systems and methods.

FIG. 6 illustrates exemplary aspects in accordance with the herein disclosed systems and methods.

FIG. 7 illustrates exemplary aspects in accordance with the herein disclosed systems and methods.

FIG. 8 illustrates exemplary aspects in accordance with the herein disclosed systems and methods.

FIG. 9 illustrates exemplary aspects in accordance with the herein disclosed systems and methods.

### DETAILED DESCRIPTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent arts.

This providing of the aspects herein may occur within a single application (“app”), or may be requested or defined in a first app and delivered in a second. As used herein, an app may be an application running on a mobile device, such as a smartphone, tablet, or laptop computer, or may be running on a stationary device such as a desktop computer, smart TV, or the like.

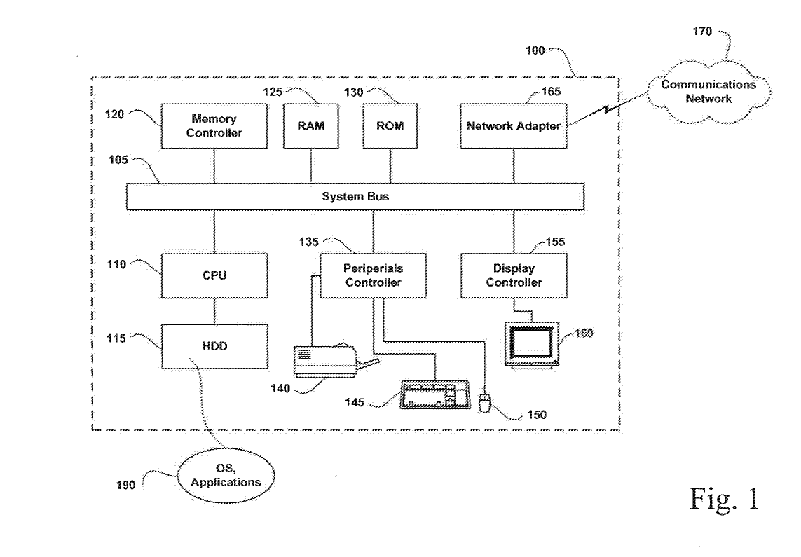

FIG. 1 depicts an exemplary computing system 100 that may be used in implementing the herein described apparatus, systems, and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable storage device, such as hard disk drive (HDD) 115, an optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a microprocessor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths.

Memory devices coupled to system bus 105 can include random access memory (RAM) 125 and read only memory (ROM) 130. Such memories include circuitry that allows information to be stored and retrieved. Data stored in RAM 125 can be read or changed by CPU 110 or other hardware devices, whereas data stored ROM 130 generally cannot. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes.

In addition, computing system 100 may contain peripheral controller 135 responsible for communicating instructions using a peripheral bus from CPU 110 to peripherals, such as printer 140, keyboard 145, and mouse 150. An example of a peripheral bus is the Universal Serial Bus (USB) bus.

Display 160, which is controlled by display controller 155, can be used to display visual output generated by computing system 100. Such visual output may include text, graphics, animated graphics, and/or video, for example. Display 160 may be an LCD-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide for access to and tracking of the data discussed herein. Communications network 170 may provide a user of computing system 100 with means of communicating and transferring software and information electronically. The network interface may be wired, such as an ethernet or cable connection to a wired network, or may be wireless, such as an air interface to a WiFi or cellular network. Additionally, communications network 170 may provide for distributed processing, which involves several computers and the sharing of workloads or cooperative efforts in performing tasks. It is appreciated that the network connections shown are exemplary and other means of establishing communications links between computing system 100 and remote users may be used.

It is appreciated that exemplary computing system 100 is merely illustrative of an exemplary computing environment in which the herein described systems and methods may operate and does not limit the herein disclosed systems and methods. Rather, computing environments having differing components and configurations may be used. That is to say, the inventive concepts described herein may be implemented in various computing environments using various components and configurations.

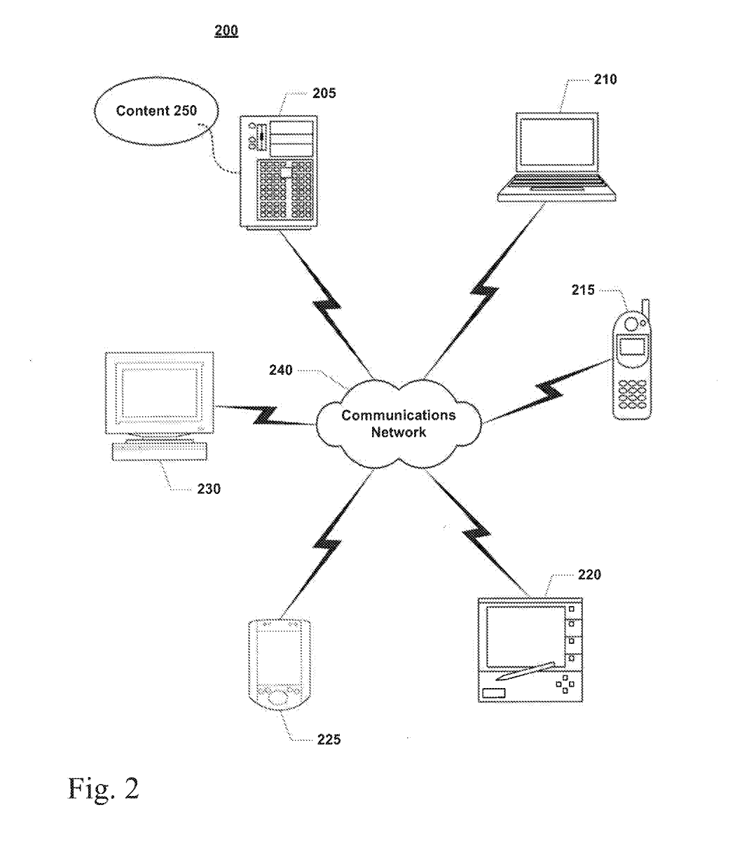

As shown in FIG. 2, computing system 100 may be deployed in networked computing environment 200. In general, aspects of the above description for computing system 100 may be applied to server, client, and peer computers and user terminals deployed in a networked environment as shown. For example, server 205, laptop computer 210, IP telephone 220, desktop computer 230, and various mobile computing devices 215, 225. FIG. 2 illustrates an exemplary networked computing environment 200, including a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone/smartphone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), and independently developed applications, to interact with server 205.

The server 205 may thus deliver and/or or communicate via applications specifically designed for mobile client devices. Client devices 215, 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example.

The herein disclosed apparatus, systems, and methods provide a computer-based platform, including server and client aspects as described in connection with FIGS. 1 and 2.

The present invention is and includes an information system for various kinds of mobile business applications. It allows business professionals to easily manage and exchange valuable information and content on any kind of device, at any place, and any time in any language. More particularly, the present apparatus, systems and methods include an Event-Identified Content (EIC) exchange and management. EIC management allows a business to manage and deliver information content to the desired audience(s), and thereby the invention helps consumers enjoy the convenience of mobile digital life, and helps content creators and providers to deliver content to the desired ones of the consumers engaged in that mobile digital life.

As defined herein, an Event is the fundamental aspect of the EIC system. Accordingly, the EIC system evolves from one or more Events. The Event includes information about who owns or creates the Event, who can access it, what it is about (the body of the Event), and where and when the Event happens. Additionally, an Event may comprise occurrences at, for example, a specific domain. An Event provides a context, and includes Item content. Accordingly, different people have different roles in each Event. Each piece of information content, herein also referred to as an Item, associated with a Event may contain a string of text, a picture, a video, audio, extracted information such as a location, and a time signature, by way of non-limiting example.

Thus, an EIC system and method provides convenient information acquisition, distribution and monetization within advanced mobile cloud computing ecosystems. The EIC is a foundation for a sustainable mobile social network for both business and consumer.

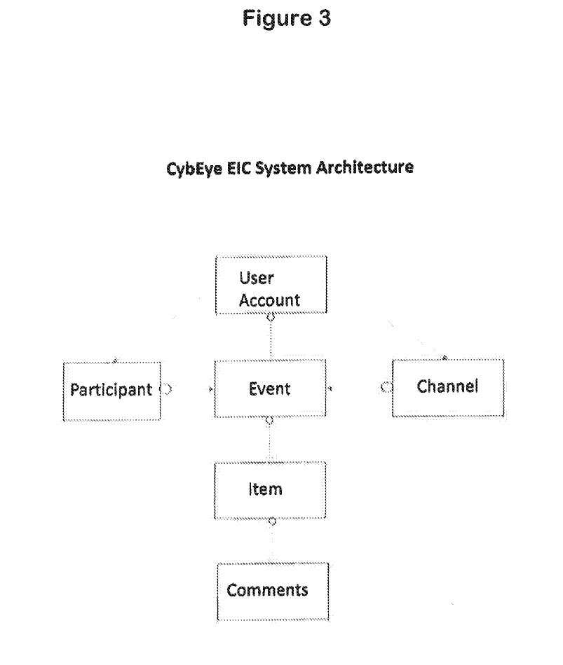

FIG. 3 is a flow diagram illustrating an embodiment of an EIC system and method, according to the present invention. The root of the system is a User, who may be a content creator and/or a content consumer. Each User's Account may have one or many Events. Events are created by the User or are of interest to the User. Each Event preferably has one host User Account, and has many channels and at least one participant User per channel. A channel may be a public searchable keyword(s) that is associated with an Event, and may be owned by a given User in a specific time frame. Participants are the Users who are interested in an Event. Each Event may include many information Items, or content, as referenced hereinthroughout.

A Channel may be a special category of keywords or tags. A User may subscribe to a Channel based upon its availability within a specified time frame. Once the User subscribes to a Channel, the user may assign his Events to that Channel. Then, any other User may discover the Events by searching that Channel. Therefore, Channel may provide a convenient method for a User to make her event publicly available and searchable.

Each Item may be defined to belong to one host Event, and may include many comments. Each Item may also be traced to where it is from (if it is not the original Item). Each Item may be content, such as a picture, a string of text, an audio or video clip, and may be denoted with a location and a time. Each comment may be signed by a particular User's Account ID. Each participant/User preferably has one Account.

Each Event may include a number of basic attributes. For example, each Event may have a name, and may have a Name-related search space assigned within the User Account. Each Event may have an access type, such as “Private”, “Social” or “Public.” For a Private Event, a participant may join the event only by the invitation from the host or his/her delegates, and the search scope is limited within the Users' account. For a Social Event, besides the host, any participant may invite other Users to join the Event, although the search scope is still limited to User's account. For a Public Event, any User may join the Event without an invitation, and the Public Event may be discoverable through a search of an assigned subscribed “Channel”.

Other Event attributes may include usage type, such as Eye, Service, Album, Check-in, Chat, Contact (profile), Device, Incoming, Link, etc. Another Event attribute may be an Event time frame, which is a time frame for the beginning and ending times of an Event. When the event end time is reached, the event may be automatically archived and/or hidden from User view. A recurring pattern, such as business applications, may be assigned to the Event time frame. Further, within the Event time frame, the locations of all participants may be automatically posted on the Event time frame.

The location of the Event may be any manner of assigning a location, such as a latitude and longitude. A radius of the location may be set, such as for a business promoting its service to Users within an intended service range. A channel, as discussed throughout, may be subscribed to by a user and may be assigned to an Event. Within an assigned channel, an event could be discovered through a system-wide search function.

By way of example, an “Eye” Event may be a public event (although Access Type may be changed at any time). This Event type may allow its host User to post anything to the general public to view. For example, this Event type may be a rich-content blog, wherein the User can post pictures, writings, and audio clips. This Event type may allow viewer Users to make comments on the posted Items, such as using both audio and text. The host User may be able to control whether comments may be viewed by all follower Users.

By way of further example, a “Service” Event may also be a public event (although Access Type may later be changed). A Service Event allows Event follower Users to post a private question for the host User to answer. The host User may make one, some, or all follower User posted questions or comments available to all follower Users by selecting to publish comments or questions. This also allows the host User to setup 1-to-1 question-and-answer for its participant Users. An “Album” Event may be a generic social Event. A Check-in Event may be a social event that is set up as recurring Event. Within the Event's time frame, the location of each participant User may be posted, i.e., the user may “check-in”, on the Event's timeline. A “Chat” Event, on the other hand, may be a private event. As such, a Chat Event may set up a private conversation activity.

Based on a User's access type to an Event, an Item may be a “JFY” (Just-For-You) Item or an “ACS” (All Can See), for example. A JFY Item may be viewed only by the recipient User, the sender User and/or the Event host User, for example. ACS Items may be exposed to all event participant Users.

An Item may have a life span. For example, an item may be a “LTD” (last-to-delete) or an “AD” (Auto Delete). Only the Item owner User and/or the Event host User may be able to delete LTD items, for example. AD Items may be deleted automatically by the system within certain time frame.

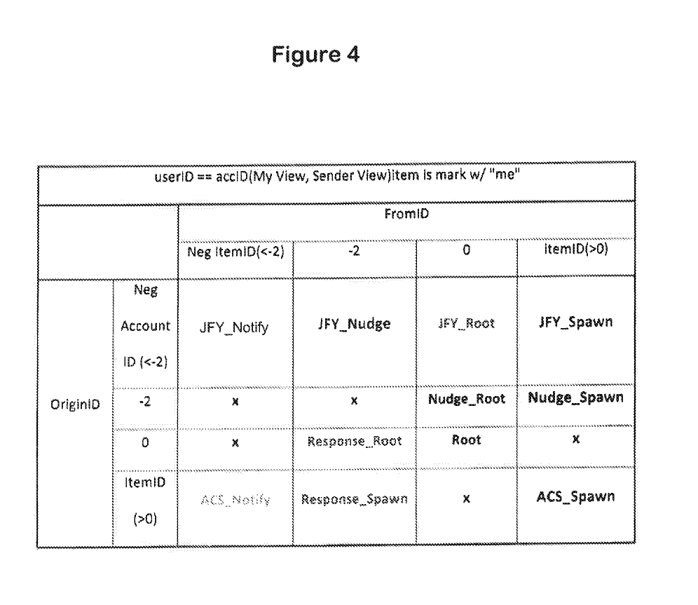

Items may be edited. For example, if an Item is originally created by a creating User, it is a “root” Item for that User. A “root” Item may then be edited only by its creator User. A “root” Item may be pinned to another events and may thus become a spawn item. In certain embodiments, only a root Item may hold all detailed contents, such as photo or audio clips, for that item. The foregoing is illustrated with respect to the Table of FIG. 4.

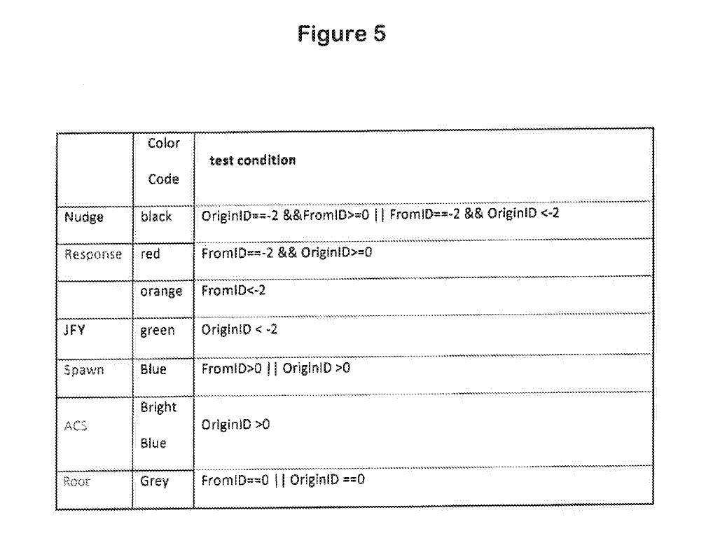

As reflected in the Tables of FIGS. 4 and 5, a JFY Item may, in embodiments, only be viewed by the recipient User and the Event host User. This attributes is thus denoted by “OriginID” for an Item and has a negative value. The absolute value of a negative “OriginID” may be the account ID of the recipient User. If the absolute value of “FromID” of an item is greater than 2, it indicates from where the Item is posted.

A Notify Item may be denoted by its “FromID”, such as if its FromID is less then −2. A Notify Item may be deleted by the system after predefined amount of time, or a Notify Item may be saved and become a regular item. If, for example, a JFY_Notify item is to be converted to a regular item, item.FromID:=abs(item.FromID), and further, accordingly, the Item may be changed to a JFY_SPAWN item.

A Root Item may be newly created by a User, or automatically by the system based on a trigger. A Nudge Item may be a particular kind of NOTIFY item, which may allow the recipient User to only view it once, such as within an author User defined time frame. A Response Item may be created by a User for responding to a certain other User's request, although it may not be directly viewable to all friend Users, for example. As such, it may be hidden from a general timeline view, except for the Event host User. A Spawn Item may be transposed from another Event, such as through a “pin”, “shake”, “promote”, “rollout” or “send”, and is preferably always traceable back to its root Item.

Pin may allow a User to put an existing Item from one Event to another. In order to pin, the source and target Event should be visible to the User, and then the Item may be posted to the target Event. Then, if the target Event allows the User to post to it, the posted Item will appear in the target Event to its participant Users.

Shake may provide a simple send mechanism for 1-to-1 or 1-to-many information delivery. Shake may not require the sender to know the recipient contact information, such as email address or account id. Rather, shake may rely on a location-time based Shake-Exchange-Server (SES).

Promote may provide an auto-invite service. Promote may be a keyword based automated process to send invitations to all Users who have followed Events which have similar corresponded search keywords.

Rollout of an item from a from-Event to a target-Event may be an automated process to post an Item to multiple relevant events. Target Events may be a “Social” or “Public” Event, and may include Items that have been pinned/sent or originated from the from-Event.

Send may allow for sending an Item to a User via his/her email address. If the User has not been registered, an invitation email may be sent out after creating a temporary account for the email address. When the new User clicks through the link in the invitation email, an account setup page for the new User to complete his/her personal registration information may be provided. If the User is a registered User, a notification email may be sent out for the user to access the Item directly through a link in the email.

A User may track, starting from a Root, the Item to find all spawned Items from the root Item. Starting from a first spawned Item, a propagation history for the root Item may be generated by tracking. Further, a User may report abuse, such as regarding an Item, at any spawn level that is tracked.

In an exemplary illustration, each Item may contain one image file, one audio clip, a title, and description. The Item may allow a User to set geo-location and service radius for the Item. The Item may be pinned to other Events. “Shake” and “roll” may provide an automated way to pin an Item to different Events. Further, it is preferable that transmission histories of an Item are effectively preserved, such as for tracking and reporting.

Also by way of example, a User may make a text and an audio comment to an Item. Thereafter, the Event host User may be able to control if all Users can read all such comments. A User can always read/review his/her own comment for any Events.

Each account may have associated therewith a profile Event. As with any other Event, a User may post numerous different Items, and corresponded comments, to the profile Event. Users may contact their friends by following the profile Event of the friend Users. Also as with any other event, by sending an invitation to a friend User, such as via that friend User's profile event, the sending User is sending his/her rich contact information, and his/her profile Event(s), to the invited friend Users. In this way, Users may, for example, use “shake” and “promote” to exchange contact information and become associated with each other.

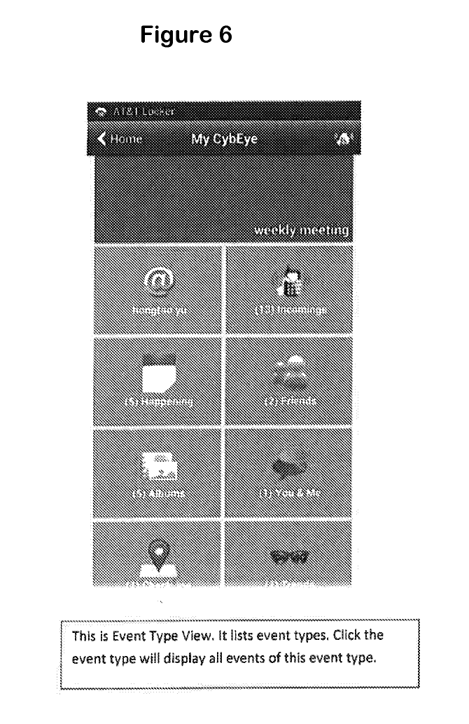

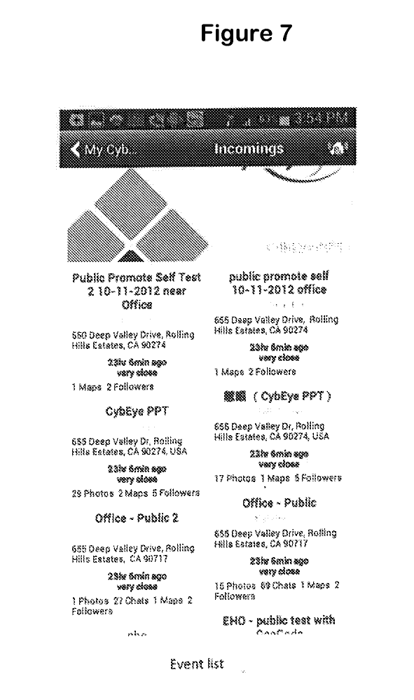

FIG. 6 illustrates an exemplary Event view. Accordingly, Events of that User account are listed. Clicking the Event type will display all Events associated with that Event type. FIG. 7 illustrates an exemplary Event list view. All Events are listed, and content, such as Items, associated with each Event listed may be accessible.

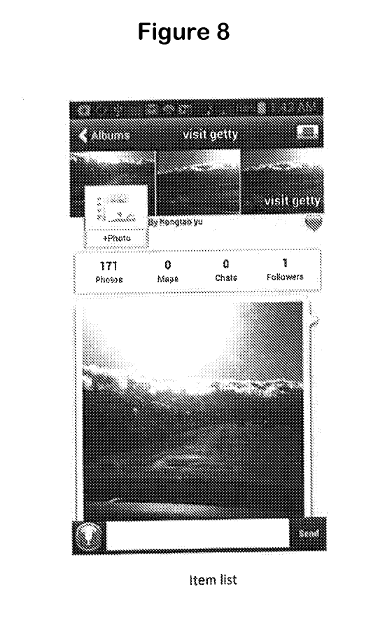

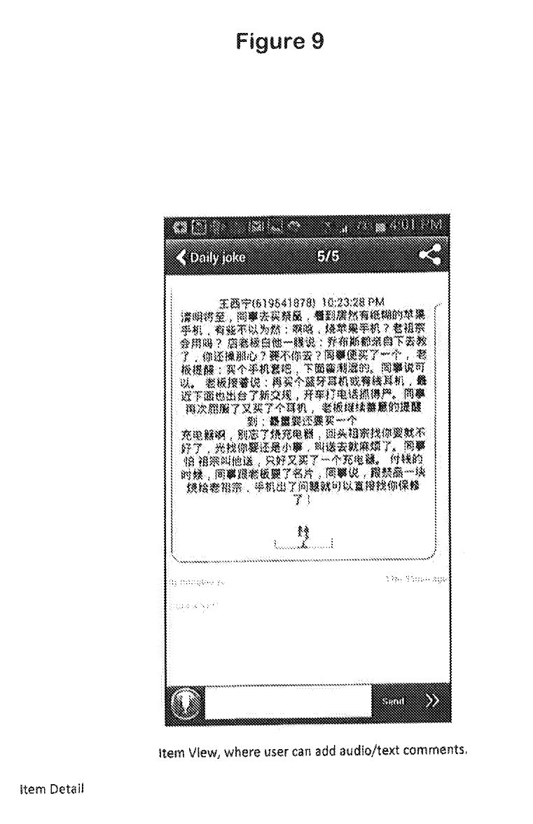

FIG. 8 is a screen shot of an exemplary Item list view. In this view, an Event has been accessed, and Items associated therewith are detailed. FIG. 9 is an exemplary comment view. In this embodiment, comments may be associated with an Item.

A User may assign a number to each of his/her Items. For Item with a positive point, any User viewing that Item may receive the specified the point by viewing. If a User views an Item with a negative point, the point(s) will be deducted from the viewing User's account. A User may be asked to purchase more points via his her account if his/her balance is below 0. Event level points may allow the Event host User to set up a per-action based Event cost structure.

In an additional example, an existing photo stock Item may be bought or located. Thereafter, the Item may be bought or traded, such as via a series of Events, and its spawn progression may be tracked. The spawning may be via a point-based Event, or via a bidding or auction system, for example.

By way of additional example, a user may take a cell-photo and publish into Facebook, such as via a “photo sync” feature. An app in accordance with the discussion herein may upload that picture to a predetermined Event. The synchronization of that photo to that Event may create the Event, create a synch to that Event for a time, such as for the next 2 hours, and may upload photos associated with that Event via 3G or WiFi, if WiFi is available.

The Event may be linked to multiple social accounts (i.e., Facebook, Google Circles, etc.). For example, a 10 day Event may be set up to correspond to a trip to Beijing, with a synch link to Facebook, and accordingly all photo Items (or those indicated by the User who synched) will upload to Facebook when selected conditions are met, i.e., when there is WiFi available.

That is, the system may, according to the discussion above with regard to FIGS. 1 and 2, provide synch, link based on conditions, upload only during the sync, and post. For example, a server may receive the link and may upload, and then redirect the Item uploaded, such as for posting to Facebook. Such a link condition may be the presence of WiFi, or may be geographically mandated, such as based on a presence in an airport, a railroad station, or Times Square in NYC. That is, a link and upload requires only an upload address, redirect address, and link settings.

Thereby, control of Items, that is, content, may be provided. A photographer or like-content generator may create an Event, set the link condition, and sync. The Event may be private, social, or public, as discussed herein. Private may entail that only an editor, such as a news editor, may see the uploaded content. The Event may be an object having Items corresponded to the Event's time, a place, link and upload address, and other Item content, such as sound to a video, may be integrated for upload, or may be separately uploaded and integrated later based on a location and time stamp of the Item. Moreover, because the Item may comprise a link to content, rather than hard data content, the content at the subject link may be modified after the fact, while the Item and Event may remain intact.

Further, the search feature discussed throughout may be interactive. For example, a User may do a text, visual, or audio search. More particularly, a User may wish to buy a Twin Towers photo. The User may, for example, say “Twin Towers”, which would return all content Items associated with all Events corresponded to the Twin Towers; or the User may say “Twin Towers photo from Twitter,” which will return only photo Items stemming from Twitter Events.

In an additional example, if a User said or typed “panda” into the present search interface, the User would receive a response comprising photos, zoo maps, conservation meetings, locations, etc. However, if the User said “free panda photos Facebook,” the User would receive results comprising solely panda photo Items from Facebook Events that did not require points for purchase.

Accordingly, the present invention provides Item content, such as photos and audio, with corresponded comments, all synced to an Event, and the linking and uploading to a link capabilities may make all of the content Items and corresponded comments modifiable or suitable for censoring after the fact. This provides improved searchability and improved data.

As such, the applications of the event-based invention described herein are almost limitless. By way of example, each building in a city may comprise one Event, and each Event may be set as private such that only limited parties, such as a tax attorney, homeowner, tax collector, bank, insurance company, and/or government official can see a particular building. The Items associated with each event may include a photo and floor plan of the building, and the Event may be the appraisal of the building for tax purposes, or the appraised value may comprise an Item and the tax collection may comprise the Event.

The Items may link to the Event, such that a link of the building to a recipient-property owner is formed. A government entity may also have title information for the building, and this title information Item may be aggregated to the Event. Accordingly, an authorized person may search to find the building, the title, and the appraisal. Further, if the Event is private, “hidden” Items may be associated with the Event, such that units within the building may comprise hidden Items that show only when searched, such as to assess taxes for an apartment, for example. Searches may be fee and/or point-based Events, for example. Further, of course, marketing, such as of banks or insurance companies, may be provided in accordance with the foregoing example.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the discussion herein and any claims appended hereto.

What is claimed is:

1. An event-identified content system, comprising:
a computer processor having associated therewith a computing memory having associated therewith computing instructions that, when executed by the processor, cause to be executed an application comprising:
an event creator, wherefrom a user creates a public, social, or private event associated with the user's account;
a content associator, wherein content is associated with the created event;
a plurality of channels, wherein the associated content is accessible to at least one other user based at least one permissions associated with a one of the plurality of channels with which the event is associated; and
a search engine, whereby is provided a keyword search for the associated content by the at least one other user.

2. The system of claim 1, wherein the event comprises at least one selected from the group consisting of a string of text, a picture, a video, audio, extracted information such as a location, and a time signature.

3. The system of claim 1, wherein the event is accessible by only one user.

4. The system of claim 1, wherein the event is accessible by a plurality of users.
